(19) United States
(12) Patent Application Publication
(10) Pub. No.: US 2002/0140543 A1
(43) Pub. Date: Oct. 3, 2002

(54) Keyless remote control security system

(76) Inventor: Chia-Cheng Chang, Taipei (TW)

Correspondence Address: RABIN & CHAMPAGNE, PC, 1101 14TH STREET, NW, SUITE 500, WASHINGTON, DC, 20005, US

(21) Appl. No.: 09/822,486

(22) Filed: Apr. 2, 2001

(51) Int. Cl. H04Q 1/00

(52) U.S. Cl. 340/5.64; 341/176

(57) ABSTRACT

A keyless remote control security system compromising a transmitter and a receiver. The transmitter consists of a push button set, a multiplexer IC, an encoder IC, a push button indication light, a radio transmission circuitry and an antenna. The receiver consists of a micro controller, a power supply, a radio receiving circuitry, a command button set, an electronic lock, a security circuitry, a main malfunction detection circuitry, a secondary, malfunction detection circuitry. The receiver and electronic lock are installed inside a door and controlled by transmitter remotely without key.

### BACKGROUND OF THE INVENTION

I. Field of the Invention

This invention relates generally to a keyless remote control security system ad, more specifically, to a keyless remote control security system that controls multiple number of doors with remote control without keys for better security purpose.

II. Description of the Prior Art

Heretofore, it is known that most of the remote control door locks have keys, for ear of the difficulty to overcome the factors that make keyless locks out of order. Users can not solve the problems easily, therefore keyless lock products are difficult to commercialize and mass production, price remains very high and market share is very low.

The present invention improves on the heretofore known locks by providing a keyless remote control security system. The keyless remote control security system is composed of a transmitter and a receiver and an electronic lock. The transmitter consists of a push button set, push button multiplexer IC, an encoder IC, a push button indication light, a radio transmission circuitry and an antenna. The receiver consists of a micro controller, a power supply, a radio receiving circuitry, a command button set, an electronic lock, a security circuitry, a main malfunction detection circuitry, a secondary malfunction detection circa. The receiver and electronic lock are installed inside a door and controlled by transmitter remotely, such mechanism offers lock without key and security purpose.

### SUMMARY OF THIE INVENTION

It is therefore a primary object of the invention to provide a keyless remote control security system compromising a transmitter and a receiver. The transmitter consists of a push button set, a multiplexer IC, an encoder IC, a push button indication light, a radio transmission circuitry and an antenna. The receiver consists of a micro controller, a power supply, a radio receiving circuitry, a command button set, an electronic lock, a security circuitry, a an malfunction detection circuitry, a secondary malfunction detection circuitry. The receiver and electronic lock are installed inside a door and controlled by transmitter remotely without key.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a block diagram of an embodiment of the present invention;

FIG. 2 is a block diagram of an embodiment of the present invention;

FIG. 3 is a cross sectional view of a further embodiment of the present invention;

FIG. 4 is a schematic diagram of another embodiment of the present invention;

FIG. 5 is a schematic diagram of another embodiment of the present invention;

FIG. 6 shows code arrangement of different function buttons of a transmitter in accordance with the present invention.

### DESCRIPTION OF THE PREFERRED EMBODIMENT

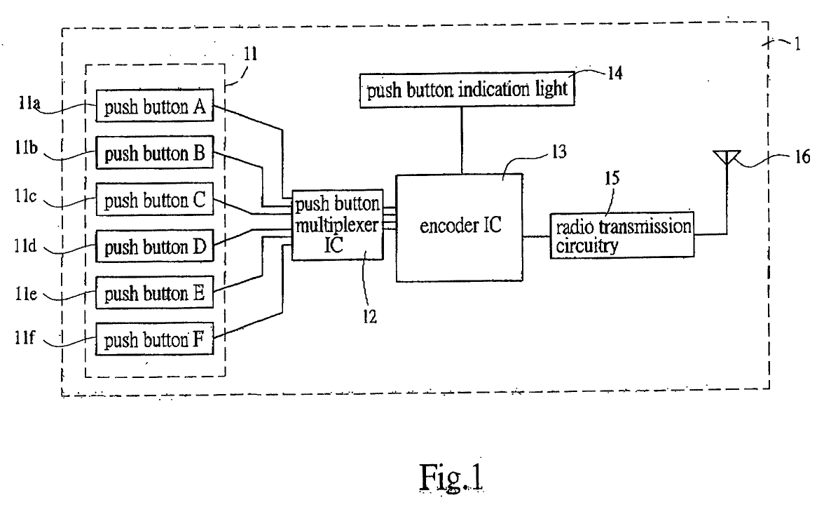

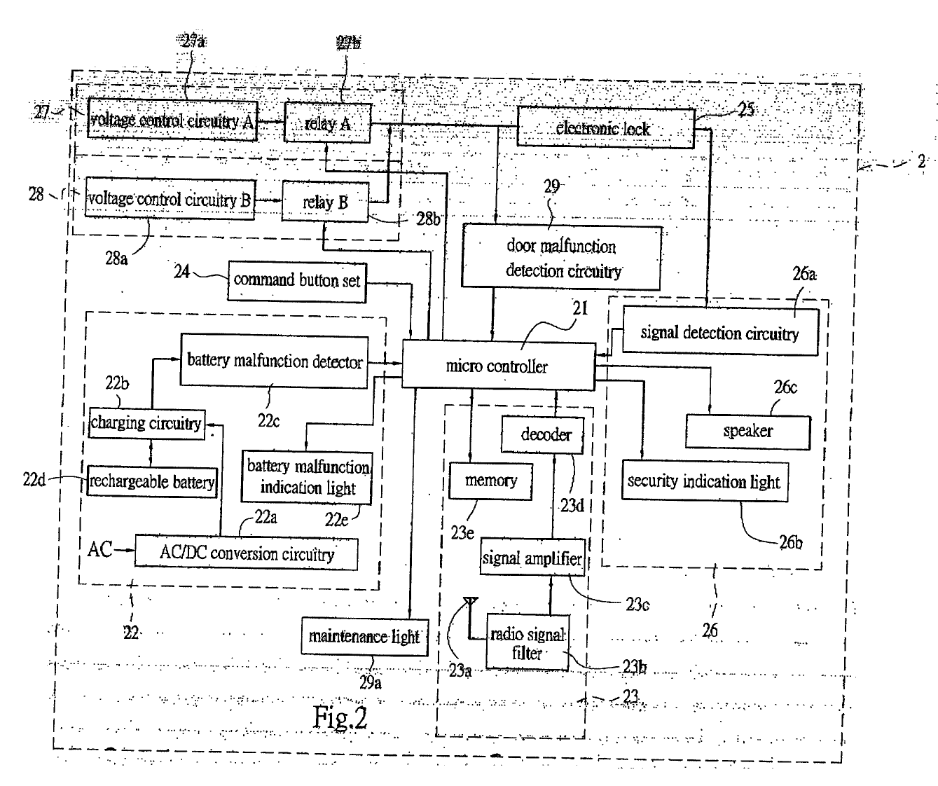

Referring to FIG. 1 and FIG. 2, the present invention is composed of a transmitter 1 and receiver 2, The functions of each component are described below:

The transmitter 1 consists of a push button set 11, a push button multiplexer IC 12, an encoder IC 13, a push button indication light 14, a radio transmission circuitry 15 and an antenna 16.

The push button set 11 controls transmission signals The button multiplexer IC 12 connects to push button set 11 and converts the signals sent by push button set 11 to proper formats.

The encoder IC 13 connects to the push button multiplexer IC 12 and processes the signals generated by the push button set 11.

The push button indication light 14 connects to the encoder IC 13 and indicates the set combination.

The radio transmission circuitry 15 connects to encoder IC 13 and antenna 16, it transmits the processed signals from encoder IC 13 and sends those signal out through antenna 16.

The receiver 2 consists of a micro controller 21, a power supply 22, a radio receiving circuitry 23, a command button set 24, an electronic lock 25, a security circuitry 26, a main malfunction detection circuitry 27, a secondary malfunction detection circuitry 28 and a door malfunction detection circuitry 29.

The micro controller 21 controls all the internal circuitry.

The power supply 22 connects to the micro controller 21 and composes of an AC/DC conversion circuitry 22a, a charging circuitry 22b, a battery malfunction detector 22c; the charging circuitry 22b connects to a rechargeable battery 22d; a battery malfunction indication light 22e connects to the micro controller 21. The AC/DC conversion circuitry 22a converts the AC power to DC current to the charging circuitry 22b and charges the rechargeable battery 22d. If the rechargeable battery has abnormal conditions, the battery malfunction detector 22c can notify the micro controller 21 to turn the battery malfunction indication light 22e on.

The radio receiving circuitry 23 connects to the micro controller 21, it includes an antenna 23a, a radio signal filter 23b, a signal amplifier 23c, a decoder 23d and memory 23e, the memory keeps all the codes of all the transmitter 1's commands to recognize the corresponding transmitter 1.

The command button set 24 connects to the micro controller 21 and sets the different command values.

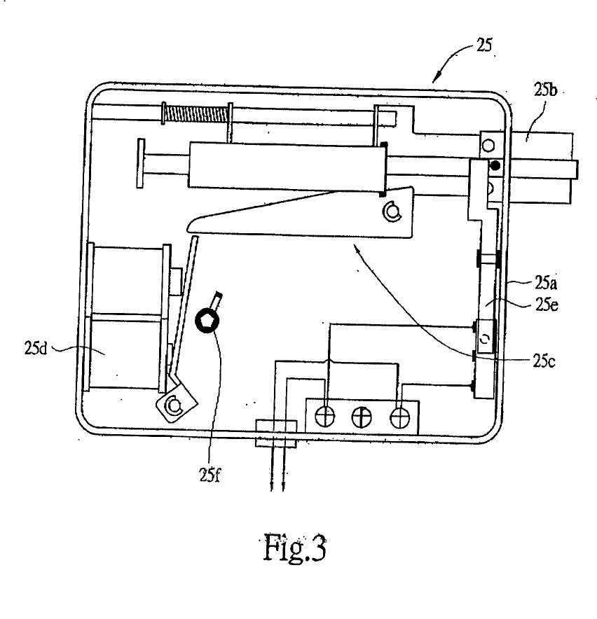

The electronic lock 25 connects to the micro controller 21 and receives the power supply signals from it to open the door. Referring to FIG. 3, the electronic lock 25 consists of a case 25a with a locking bolt 25b. The locking bolt 25b links to a bolt guide 25c, the bolt guide 25c is controlled by a electromagnetic steel 25d to push and pull the locking bolt, the locking bolt 25b also connects to a micro switch 25e.

The security circuitry 26 connects to the micro controller 21 and the micro switch 25e of the electronic lock 25. The security circuitry 26 consists of a signal detection circuitry 23a, a security indication light 26b and a speaker 26c. Once the signal detection circuitry 26a is set to security mode, the door is locked and the power of door is turned off to avoid the door is opened by remote control accidentally, the security indication light 26b is also on to indicate the security mode. The signal detection circuitry 26a monitors the micro switch 25e of the electronic lock 25, if the electronic lock is open abnormally, the micro controller 21 will sound speaker 26c for attention.

The main malfunction detection circuitry 27 connects to micro controller 21, it consists of a voltage control circuitry A 27a and a relay A 27b. The main malfunction detection circuitry 27 controls the power to the electronic lock 25 to open or. close it. The micro controller 21 monitors the main malfunction detection circuitry 27 to detect whether it is function. properly or not.

The secondary malfunction detection circuitry 28 connects to micro controller 21 if consists: of a voltage control circuitry B 28a and a relay B 28b. If the main malfunction detection circuitry 27 is out of order, the micro controller 21 activates the secondary malfunction detection circuitry 28 and maintenance light 29a to indicate the malfunction.

The door malfunction detection circuitry 29 connects to the micro controller 21 and the electronic lock 25, it monitors the power of the electronic lock 25 is working properly or not.

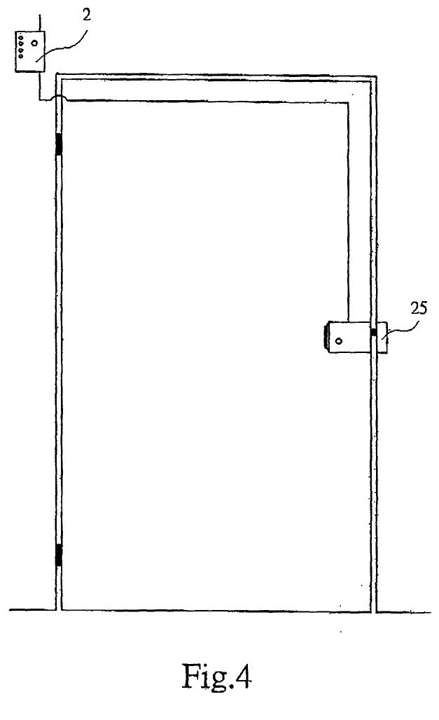

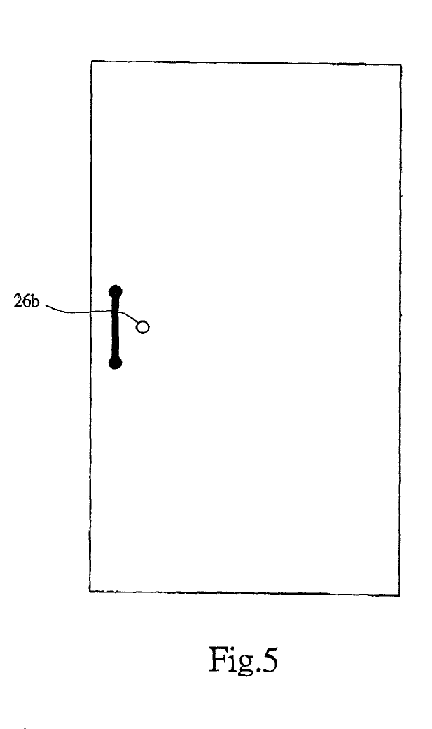

Based on above description and referring to FIG. 4 and FIG. 5, the receiver 2 and the electronic lock 25 are installed inside of a door. To open the door, a user presses push button set 11 of transmitter 1 first, then the transmitter 1 issues radio signals accordingly. The radio receiving circuitry 23 of the receiver 2 receives the command and let micro controller 21 to open the electronic lock 25, this is how to open the door without key and achieve security purpose.

The push button set II of transmitter 1 consists of push button A 11a, push button B 11b, push button C 11c, push button D 11d, push button E 11e and push button F 11f.

The other advantage of this invention is one receiver 2 can memories codes of multiple transmitter 1, one transmitter I can also control multiple receiver 2. In order to increase the functionality of this system, the memory size of memory 23e of receiver 2 can be enlarged; the receiving range of the antenna 23a of each receiver 2 can be increased. Encoding method of transmitter 1 can be modified to avoid the interference among multiple receiver 2 to achieve one transmitter 1 to remotely control multiple doors: community entrance, apartment gate, resident door, garage door and automobile lock without lots of keys.

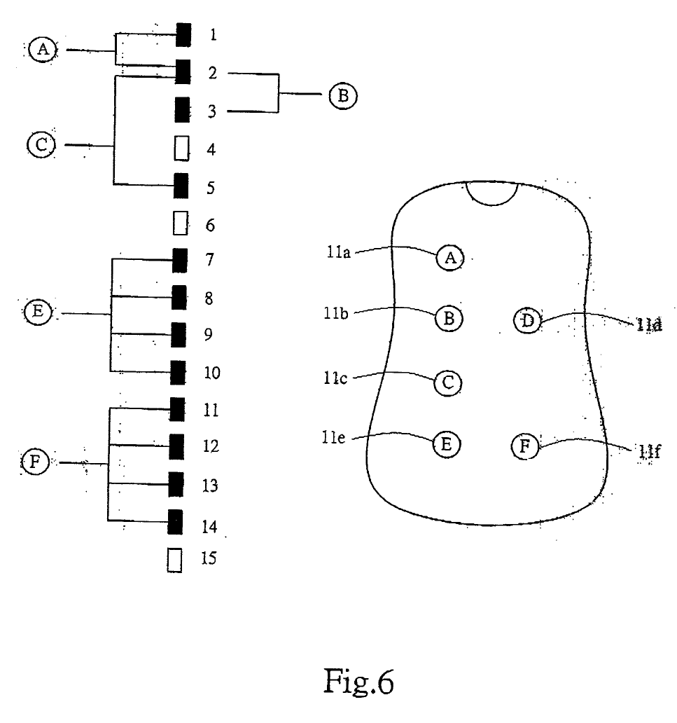

Referring to FIG. 6, this figure shows the code arrangement of the corresponding push button set 11 of transmitter 1. A transmitter 1 can be set for different receiver 2: automobile remote control, garage door opener or different door openers whenever, wherever needed. Every receiver 2 has three different preset methods to choose an open push button; this invention has fifteen preset function codes, every push button of receiver 2 can h a corresponding function code, therefore every receiver 2 can receives clear signal without interference. One transmitter 1 can apply one preset function code for different receiver 2.

Referring to FIG. 6, a transmitter 1 has six push buttons, three push button are used to open doors (push button A 11a, push button B 11b, push button C 11c. All the six push buttons (push button A 11a, push button B 11b, push button C 11c, push button D 11d, push button E 11e, push button. F 1f) are preset with a function code. Every receiver 2 has three preset door open methods: A, B and C, choose one of the push buttons used to open doors (push button A 11a, push button B 11b, push button C 11c). For example, if the receiver 2 of an electronic lock 25 chooses method A, then the corresponding door open button is push button A 11a that occupies preset function code 1, 2; if the receiver 2 chooses method B, then the corresponding door lock button is push button B 11b that occupies preset function code 3, 2; if the choice is method C, then the corresponding door lock button is push button C 11c that occupies preset function code 5, 2. Preset function code 1, 3 and 5 are corresponding to door open push buttons: push button A 11a, push button B 11b, push button C 11c. Preset function code 2 is a door lock push button and corresponding to push button D 11d, this is how to multiple transmitter 1 with multiple receiver 2. However different receiver 2 must have different receiving range by adjusting its antenna 23a. When the transmitter 1 is intended to be an automobile remote control, user has to push remote control push button (push button E 11e) for a period of time, the preset function codes are changed to preset function code 7, 8, 9 and 10. The functions of push buttons change automatically: push button A 11a becomes door lock opener, push button B 11b becomes automobile locator, push button C 11c becomes door locker, push button D 1d becomes power-off control. When the transmitter 1 is intended to be a garage door controller, user has to push the garage door controller push button (push button F 11f) for a period of time, the preset function codes are changed to preset function code 11, 12, 13 and 14. The functions of push buttons change automatically: push button A 11a becomes door opener, push button B 11b becomes hold, push button G 11c becomes door closer, push button D 11d becomes power-off control. The functions of push button E 11e and push button F 11f also apply to multiple transmitter 1 with multiple receiver 2. However different receiver 2 must has different receiving raze to avoid interference.

The electronic lock 25 connects to security circuitry 26; the signal detection circuit 26a of the security circuitry 26 connects to micro switch 25e of the electronic lock 25. When the signal detection circuitry 26a is set to security mode and the security indication light 26b. is turned on, the signal detection circuitry 26a monitors the micro switch 25e of the electronic lock 25. If the electronic lock 25 is open abnormally and triggered the micro switch 25c, the signal detection circuitry 26a will turn on speaker 26b for attention. The AC/DC conversion circuitry 22a of power supply connects to wall power outlet and converts alternative power source to DC current to charge the rechargeable battery 22d of the charging circuitry 22b. The rechargeable battery 22d is monitored by the rechargeable battery detection circuitry 22c, if the rechargeable battery 22d is out of order, then the micro controller 21 turns on battery malfunction light 22e for maintenance people to repair.

The main malfunction detection circuitry 27 connects to electronic lock 25 and micro controller 21, it apples the voltage control circuitry A 27a and the relay A 27b to control the operations of electronic lock 25. The micro controller 21 monitors the power on and off operations of relay A 27b to see if the power supply function properly. If the main malfunction detection circuitry 27 works abnormally, the operation switches to the secondary malfunction detection circuitry 28, the malfunction light 29a is turned on for attention.

Referring to FIG. 3, if the electronic lock 25 is out of order because of irresistible reasons, human errors or mechanical failures, user can apply an electrical drill to open a small hole on the location on the manual lock switch 25f of the case 25a to make the manual lock switch 25f reachable and moveable. Turn the manual lock switch 25f can move the bolt guide 25c and finally trigger the locking bolt 25b to open the door.

The shaft of the manual lock switch 25f is in pentagon shape, it a special design and is difficult to manufacture therefore offers higher security purpose.

The electronic lock 25 can have a keyhole and key (nor shown in FIG) for backup purpose.

Wile a preferred embodiment of the invention has been shown and described in detail, it will be readily understood and appreciated that numerous omissions, changes and additions may be made without departing from the spirit and scope of the invention.

What is claimed is:

1. A keyless remote control security system comprising:
a transmitter having
a push button set controlling transmission signals;
a push button multiplexer IC connecting to said push button set and converting the signals sent by said push button set 11 to proper formats;
an encoder IC connecting to said push button multiplexer IC 12 and processing the signals generated by said push button set;
a push button indication light connecting to said encoder IC and indicating the set combination;
a radio transmission circuitry transmitting the processed signals from said encoder IC and sending those signal out through an antenna;
and a receiver having
a micro controller controlling all the internal circuitry;
a power supply connecting to said micro controller and having an AC/DC conversion circuitry, a charging circuitry, a battery malfunction detector; the said charging, circuitry connects to a rechargeable battery, a battery malfunction indication light connects to said micro controller, said AC/DC conversion circuitry converts the AC power to DC. current to said charging circuitry and charges the rechargeable battery, while rechargeable battery has abnormal conditions, a battery malfunction detector notifies said micro controller to turn said battery malfunction indication light on;
a radio receiving circuitry connecting to said micro controller and consisting of an antenna, a radio signal filter, a signal amplifier, a decoder and memory, said memory keeps all the codes of all the said transmitter commands to recognize the corresponding said transmitter;
a command button set connecting to said micro controller and seting the different command values;
an electronic lock connecting to said micro controller and receiving the power supply signals from said micro controller to open the door, said electronic lock 25 consisting a case with a locking bolt, said locking bolt links to a bolt guide, said bolt guide been co tolled by a electromagnetic steel to push and pull said locking bolt, said locking bolt connects to a micro switch;
a security circuitry connecting to said micro controller and said micro switch, said security circuitry consists of a signal detection circuitry, a security indication light and a speaker, while said signal detection circuitry is set to security mode, the door is locked and the power of door is turned off to avoid the door is opened by remote control accidentally, said security indication light is also on to indicate the security mode, said signal detection circuitry monitors said micro switch, if said electronic lock is open abnormally, said micro controller sounds said speaker;
a main malfunction detection circuitry connecting to said micro controller and consisting of a voltage control circuitry A and a relay A, said main malfunction detection circuitry controls the power to said electronic lock to open or close, said micro controller monitors said main malfunction detection circuitry;
a secondary malfunction detection circuitry connecting to said micro controller and consisting a voltage control circuitry B and a relay B, while said main malfunction detection circuitry fails, said micro controller activates said secondary malfunction detection circuitry and a maintenance light;
a door malfunction detection circuitry connecting to said micro controller and said electronic lock, said door malfunction detection circuitry monitors the power of said electronic lock working properly.

2. The keyless remote control security system recited in claim 1, wherein said electronic lock having a manual lock switch, tuning said manual lock switch can move said bolt guide and trigger said locking bolt to open the door, a shaft of said manual lock switch is in pentagon shape.
